(19) United States
(12) Patent Application Publication
(10) Pub. No.: US 2003/0077016 A1
(43) Pub. Date: Apr. 24, 2003

(54) Connection of a wheel hub bearing unit to a motor vehicle suspension standard

(76) Inventors: Fabrizio Iarrera, Torino (IT); Mauro Picca, Perosa Argentina (IT); Paolo Bertetti, Torino (IT); Andreas Ruetter, Pinerolo (IT)

Correspondence Address: MERCHANT & GOULD PC, P.O. BOX 2903, MINNEAPOLIS, MN, 55402-0903, US

(21) Appl. No.: 10/181,761

(22) PCT Filed: Jan. 25, 2001
(86) PCT No.: PCT/IT01/00039

(30) Foreign Application Priority Data
Jan. 28, 2000 (IT) TO2000 A 000084

(51) Int. Cl. F16C 43/00; F16C 13/00

(52) U.S. Cl. 384/537; 384/544

(57) ABSTRACT

A suspension standard (10) for a motor vehicle has a cylindrical seat (11) for accommodating the outer, non-rotating race (13) of a wheel hub bearing (12). At least one body (16; 16′, 16″; 22) distinct from the standard (10) and the outer bearing race (13) has end portions (16a, 16b) extending in a radially outer direction on opposite sides (10a, 10b) of the standard so as to axially lock the bearing with respect to the standard.

The present invention refers to the mounting of a hub bearing of a motor vehicle wheel to a suspension standard.

U.S. Pat. No. 5,782,566 discloses a bearing-suspension standard assembly in which the outer race of the bearing has a shoulder on one side and, on the other side, a tubular end portion extending from a seat of the standard in which the bearing is fitted. The part of the tubular end portion projecting beyond the standard is cold deformed by rolling in a radially outer direction against a side surface of the standard, so as to lock the bearing on the suspension standard.

In order that the rolling operation is effective, the tubular end portion must not be hardened; the outer race therefore may not be hardened in its entirety but should be induction-hardened only in the zones of the raceways.

Some radial interference is provided between the outer bearing race and the standard seat in which the outer race is accommodated, so as to attain a more steady axial and circumferential locking of the outer race with respect to the standard.

WO-A-99/34126 discloses a bearing and suspension standard assembly for a motor vehicle wheel, comprising a suspension standard, a bearing with a non-rotating outer race fixedly mounted in an essentially cylindrical seat of the standard. Locking means in form of a sleeve element and a retainer ring have end portions extending in a radially outer direction that co-operate with the outer bearing race and opposite side surfaces of the standard so as to axially lock the bearing with respect to the standard.

The present invention has the object of providing a bearing-suspension standard assembly for a motor vehicle wheel, mainly addressing the problem of optimising the axial locking between the suspension standard and the bearing outer race.

Another object of the invention is to provide a connection for the bearing which allows to use bearings having an outer race with minimal modifications with respect to the so-called bearings of the first generation, so as to manufacture such components through cost-effective processes. In particular, it is an object of the invention to provide several kinds of connections which allow to use bearings with outer races hardened as a whole, without precluding the possibility of exploiting any cold deforming method, such as rolling, for fixing them to the standard.

It is a further object of the present invention to improve the locking of a bearing in a suspension standard made of aluminium. As known, with aluminium standards one can not rely on a locking effect given by the radial interference between the bearing and the standard, as, owing to the different thermal expansion coefficients of aluminium and steel, at the interface between the bearing and the standard the radial interference fails upon reaching normal operation temperatures (about 70° C.). The present invention therefore provides a connection which relies on the axial locking of the bearing with respect to the standard.

According to another method of mounting a bearing in a suspension standard made of aluminium, the bearing seat is formed by a steel bushing die-cast in aluminium. The outer race of the bearing is then forcefully fitted in the steel bushing. This technique involves a first complication, inherent in the manufacturing process of the standard. In addition, it is difficult to remove the steel bushing from the aluminium standard by turning for recycling the vehicle components, in accordance with the actual tendency of specifications dealing with recycle.

According to the present invention, there is provided a bearing-suspension standard assembly as defined the appended claims.

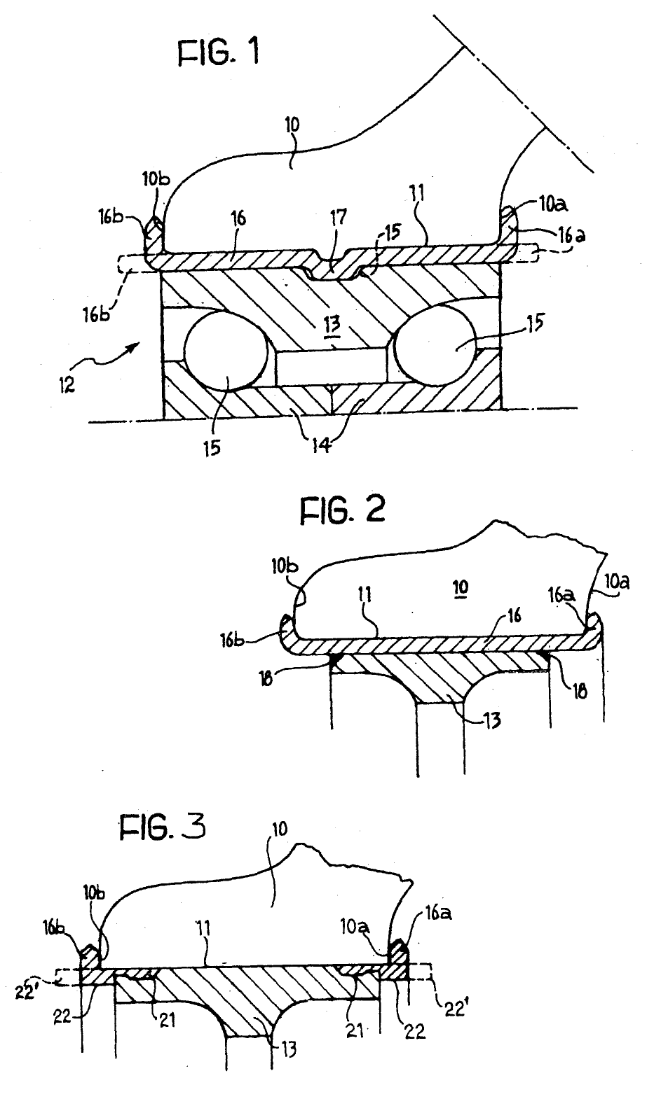

The invention is herein after described with reference to some embodiments thereof, given by way of non-limiting example, reference being made to the accompanying drawings, in which FIGS. 1 to 4 are axial sectional views showing four alternative embodiments of the wheel-suspension standard assembly according to the invention. For simplicity, in most figures only the radially outer race of the bearing is shown, and not the whole bearing.

With reference initially to FIG. 1, a suspension standard for a wheel of a motor vehicle is indicated 10. As stated in the preamble of the description, the standard may be of aluminium; however, reference to this possible field of use should not be interpreted as in any way limiting the scope of the patent.

In the suspension standard 10 there is formed an essentially cylindrical axial seat 11 adapted for receiving a bearing indicated overall 12. The bearing 12 includes a radially outer stationary race 13, a radially inner rotating race 14, in this example a consisting of a pair of half-races fitted side to side, and one or more sets of rolling elements 15 interposed between the outer race 13 and inner race 14.

Designated 13a is the outer cylindrical service of the outer race 13, in which there is formed, at an essentially central position or in any case intermediate its and portions, a radial recess 15, preferably in form of a circumferential groove.

Prior to the insertion of the bearing in the standard seat 11, a cylindrical tubular sleeve 16 is fitted onto the outer race 13, sleeve 16 having an undeformed axial length exceeding that of the seat 11. Sleeve 16 is then permanently deformed at the bearing groove 15, so as to yield a deformed portion 17 projecting within the groove 15 and locking the sleeve 16 axially with respect to the outer race 13.

Once such locking action has been carried out, the unit comprised of the bearing 12 with the sleeve 16 is inserted in the standard seat 11. The axial end portions 16a and 16b of the sleeve, which are initially undeformed as shown in phantom, are bent by cold forming, preferably by rolling, in a radially outer direction against the respective inner 10a and outer 10b side surfaces of the standard 10. The bearing 12 is so securely fixed to the suspension standard.

According to a possible variant of the embodiment shown in FIG. 1, the sleeve 16 may be preformed such that only one of its end portions, 16a or 16b, is already radially folded, or flanged, so as to require a rolling operation to be carried out only on the other end portion (16b or 16a) to lock the bearing axially on the standard.

While it is preferable that a slight radial interference is provided between sleeve 16 and the cylindrical outer service 13a of the outer race 13 so as to lock the sleeve 16 with respect to the outer race 13 while the protruding portion 17 is being cold-headed into the groove 15, it is advantageous to provide a slight radial interference between the sleeve 16 and cylindrical seat 11 of the standard to keep the sleeve-bearing unit steady with respect to the standard while rolling the end portion (16a or 16b) that is deformed first. In any case, this interference does not serve to secure the bearing in operation but simply to facilitate a correct axial positioning of the bearing-sleeve unit during the rolling step.

Referring now to FIG. 2, there is shown an alternative embodiment in which the outer race 13 of the bearing is fixed to the tubular sleeve 16 by welding, in this example at both the axial end portions of the outer race 13, as indicated by reference numerals 18. Once the outer race 13 and sleeve 16 are connected, the so formed unit is inserted in the standard seat 11 and locked to the standard 10 by cold forming of the axial end portions 16a and 16b of the sleeve 16.

Also for the embodiment shown in FIG. 2, there may be a variant in which the sleeve 16 is preformed so as to exhibit one of its axial end portions already radially folded (or flanged) before it is fitted to the standard.

To practice the example of FIG. 2 it is necessary that the outer race 13 is made of weldable steel, for example SAE 1070 or SAE 1055, and that the tubular sleeve 16 has a low carbon content.

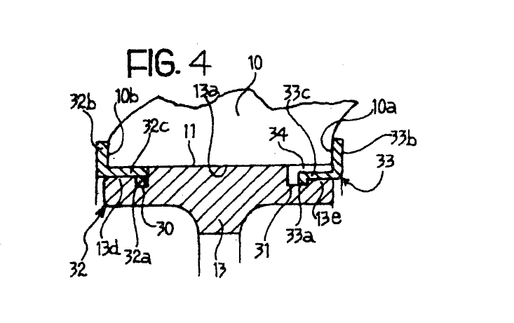

A further embodiment is shown in FIG. 3, where recesses 21 are formed in the outer bearing race 13 and in particular in the radially and axially outer zones; the recesses 21 constitute anchoring seats for a pair of annular edge bodies 22 made of sintered material, which serve to provide axial locking means with portions (still indicated 16a and 16b) extending beyond the opposite side surfaces of the standard.

The edge annular bodies 22, initially straight as indicated in phantom at 22; are applied to an outer race 13 having recesses 21; the bearing is then inserted in the standard seat 11. The edge bodies 22 are then bent by rolling, folding them in a radially outer direction, so as to clamp the opposite side faces of the standard as shown in the drawing in full line.

According to a possible variant of the embodiment FIG. 3, one of the two edge bodies 22 can be applied to the outer bearing race in its final shape with its flanged end portion already protruding in a radially outer direction; in this way, after slipping the bearing in the standard, only the other annular edge body has to be cold deformed to lock the bearing axially with respect to the standard.

In the embodiment of FIG. 4, two recesses 30, 31, preferably in form of circumferential grooves, are obtained in the radially outer surface 13a near the edges thereof for receiving respective annular locking elements 32, 33. The annular elements 32, 33, preferably in form of open rings, are shaped so as to each have: a respective portion 32a, 33a, protruding in an radially inner direction to engage a respective groove 30, 31; a respective portion 32b, 33b protruding in a radially outer direction for abutting against the respective side surfaces 10a and lob of the standard; and a respective essentially cylindrical portion 32c, 33c joining the said portions 32a and 32b, and portions 33a and 33b. The cylindrical portions 32c and. 33c are fitted between the cylindrical standard seat 11 and the edges 13d and 13e of the outer race 13. Both edges 13d and 13e have an outer diameter slightly smaller, with respect to the central part of the race 13, for accommodating the portions 32c and 33c.

One of the edge portions of the race 13, in this example the axially inner edge portion 13e has a diameter smaller than the other edge portion 13d so as to define with the seat 11 a wider gap 34 for facilitating the insertion of the annular element 33. The mounting of the bearing on the standard takes place as follows. First the annular locking element 32 is fitted to the outer race 13, with the portion 32a engaging in the groove 30; then, the bearing is inserted in the seat 11, with the portion 32b abutting against the side surface 10a of the standard. The annular element 33 is then elastically widened, against its elastic force, and it is inserted in the gap 34 until the portion 33a snaps into the groove 31 and the portion 33b abuts against the side surface lob of the standard. The outer race 13 is so locked on the standard.

As will be apparent, in all the described embodiments, the outer race 13 may be made from an annular element for bearings of the so-called first generation, carrying out a minimal additional machining operation to form the groove 15 in the example of FIG. 1 and the edge recesses 21 in the example of FIG. 5. Above all, the outer bearing race may advantageously be hardened as a whole, without having to carry out a more expensive induction hardening in order to harden only the zone of the raceways.

1. A bearing and suspension standard assembly for a motor vehicle wheel, comprising:
a suspension standard (10), in particular made of aluminium,
a bearing (12) with a non-rotating outer race (13) fixedly mounted in an essentially cylindrical seat (11) of the standard (10), and
locking means co-operating with the outer bearing race (13) and opposite side surfaces (10a, 10b) of the standard (10) so as to axially lock the bearing with respect to the standard, wherein said locking means are formed by end portions (16a, 16b) extending in a radially outer direction from at least one body (16; 22) distinct from the standard (10) and the outer bearing race (13),
characterised in that said at least one body is and fixedly secured to the outer race, and at least one of said end portions (16a, 16b) is bent against a side surface (10a, 10b) of the standard (10) by cold forming after insertion of said at least one body (16; 22) in said seat (11).

2. The assembly of claim 1, wherein both said end portions (16a, 16b) are bent against respective side surfaces (10a, 10b) of the standard (10) by cold forming after insertion of said at least one body (16; 22) in said seat (11).

3. The assembly of claim 1, wherein said locking means (16a, 16b) are opposite end portions of an axial sleeve (16) radially interposed between the bearing outer race (13) and the standard seat (11).

4. The assembly of claim 3, wherein the outer race (13) has at least one radial recess (15) in its outer cylindrical surface (13a) and wherein said sleeve (16) is joined to the outer race (13) by deforming a portion (17) of the sleeve in said recess (15).

5. The assembly of claim 3, wherein the outer race (13) is made of weldable steel and the sleeve (16) is joined to the outer race (13) by welding (18).

6. The assembly of claim 1, wherein said locking means are provided by two annular bodies (22) of metallic sintered material, anchored in corresponding seats (21) formed near the end portions of the outer race (13).

7. A bearing and suspension standard assembly for a motor vehicle wheel, comprising:
a suspension standard (10), in particular made of aluminium,
a bearing (12) with a non-rotating outer race (13) fixedly mounted in an essentially cylindrical seat (11) of the standard (10), and
locking means co-operating with the bearing outer race (13) and opposite side surfaces (10a, 10b) of the standard (10) for axially locking the bearing with respect to the standard,
characterised in that
said locking means are formed by end portions (32b, 33b) radially outwardly extending from a pair of annular members (32, 33) in form of open rings arranged for engaging respective recesses (30, 31) formed in proximity of axially opposite edge portions (13d, 13e) of the outer race (13),
each annular element (32, 33) has: a first portion (32a, 33a) protruding in an radially inner direction to engage a respective recess (30, 31) of the outer race, a second portion (32b, 33b) protruding in a radially outer direction for abutting against a respective side surface (10a, 10b) of the standard, and a third cylindrical portion (32c, 33c) joining the said first and second portions (32a, 32b; 33a, 33b);
the edge portions (13d, 13e) of the outer race (13) having outer diameters smaller than the central part of the race (13), for accommodating said third portions (32c, 33c).

8. An assembly according to any one of the preceding claims, wherein the outer race (13) is hardened as a whole.
